(19) United States
(12) Patent Application Publication
(10) Pub. No.: US 2008/0034128 A1
(43) Pub. Date: Feb. 7, 2008

(54) Graphical User Interface Operations

(75) Inventor: David E. Evans, Oxon (DE)

Correspondence Address: HAMILTON & TERRILE, LLP;IBM RSW, P.O. BOX 203518, AUSTIN, TX, 78720, US

(73) Assignee: INTERNATIONAL BUSINESS MACHINES CORPORATION, Armonk, NY (US)

(21) Appl. No.: 10/561,686

(22) PCT Filed: Dec. 2, 2003
(86) PCT No.: PCT/GB03/05267

§ 371 Date: Apr. 24, 2007

(30) Foreign Application Priority Data
Jun. 28, 2003 (GB) 0315151.1

(51) Int. Cl. G06F 3/00

(52) U.S. Cl. 710/18

(57) ABSTRACT

A method of operating an application program having a graphical user interface (GUI) includes the steps of (i) predicting the next user input to the GUI; (ii) pending receipt of the next user input, executing a preparation portion of GUI code that provides the GUTI function required by the predicted user input; (iii) receiving the next user input; and (iv) only when the next user input corresponds to the predicted user input, processing an activation portion of said GUI code to complete the required GUI function.

### FIELD OF INVENTION

The present invention relates to the operation of graphical user interfaces.

### BACKGROUND OF THE INVENTION

The efficient operation of application software on a computer system is often heavily dependent on the efficiency of operation of the program code that provides the graphical user interface (hereafter ‘GUI code’). Much application software operates in such a way that the GUI sits idle until the computer user provides input via the GUI. The GUI code responds to user input that requires a change in the GUI to effect such a change. The amount of processing time required for the GUI code to carry out the change will depend on the action requested by the user. For example, in a word processing application, the depression by the user of an alphanumeric key during text input will require a minimal amount of processing power to effect the change in the GUI. On the other hand, the selection of an option to display a file menu, will require the GUI code to allocate GUI resources to display a pop-up menu; put all of the entries in the menu; and then display the menu. This type of operation and other more complex GUI operations may result in a perceptible time lag between the user input and the change in the GUI presented to the user. It would be desirable to decrease such time lags.

### SUMMARY OF THE INVENTION

Accordingly, in a first aspect of the invention there is provided a method of operating an application program having a graphical user interface (GUI), the method including the steps of: predicting a next user input to the GUI; pending receipt of the next user input, executing a preparation portion of GUI code that provides the GUI function required by the predicted user input; and determining whether the predicted user input corresponds to the actual next user input and, on a positive determination, processing an activation portion of said GUI code to complete the required GUI function.

The GUI code for each GUI function is logically divided into a preparation block and an activation block. The preparation block includes code that, when executed, has no side effects on user data and no visible clue (i.e. visible in the GUI) that it has been performed. The activation block includes code that, when executed, performs all the steps necessary to complete the required GUI function including making visual changes to the GUI.

Thus, by means of the present invention, a prediction is made as to the likely next user input and the preparation block of the GUI code associated with that predicted user input is executed. If the next user input is as predicted, the user-perceptible delay in the change to the GUI is reduced by the amount of time involved in execution of the preparation block.

The prediction can be made in a number of different ways. One technique involves maintaining a record of user inputs at different states of the GUI. The prediction is then based on the most common next user input at a particular state. If, for example, on a GUI “file menu” only a few of the available options are ever chosen by the user and one is more frequently chosen than the others, then the prediction will involve selecting the user input associated with the more frequently chosen option. This technique can thus be viewed as being based on long term user input statistics. In the following description this technique is referred to as a ‘Footprint’.

Another technique that is instead based on short term statistics can be used in conjunction with the above described technique. This short term prediction method relies more on an analysis of user inputs immediately preceding the awaited user input. Thus, for example, if a user wishes to move to the top of a word processing document, he/she may achieve this by depressing the up arrow a number of times. At some point in this sequence of up arrow user inputs, a prediction based on short term statistics would predict that the next input was an up arrow whereas a prediction based on long term statistics might predict the next user input as something other than depression of the up arrow key, for example, depression of the space bar. Thus, this short term technique may result in a more accurate prediction than the long term technique. In the following description, the short term technique is referred to as a ‘Scent’.

### BRIEF DESCRIPTION OF DRAWINGS

Embodiments of the invention are described below in detail, by way of example, with reference to the accompanying drawings in which:

FIG. 1 shows a data processing apparatus in which the present invention may be implemented;

FIG. 2 is a diagram indicating the transition between example GUI states;

FIG. 3 is a flow diagram showing the steps involved in a method according to a preferred embodiment of the present invention;

FIG. 4 is a flow diagram showing the steps involved in the prediction technique of an embodiment of the present invention;

FIG. 5 is a flow diagram showing the steps involved in the update of user input records according to an embodiment of the present invention; and

FIG. 6 is a schematic representation of footprint and scent counter updates according to an embodiment of the present invention.

### DETAILED DESCRIPTION OF EMBODIMENTS

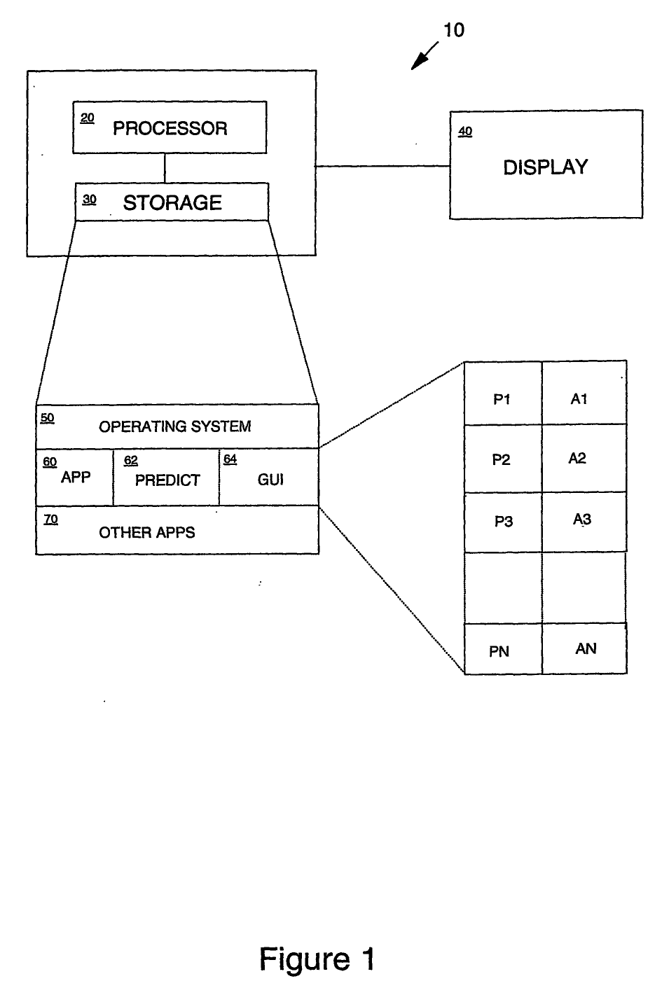

FIG. 1 is a schematic representation of a computer system 10 suitable for embodying the present invention. System 10 includes a processing function 20, memory 30 and display 40. Memory is made up of volatile storage (e.g. RAM) and non-volatile storage (e.g. disk storage device). Operating system 50 and application 60, 70 software is typically stored on the non-volatile storage and transferred as required to volatile storage to be executed by the processing function. In a typical personal computer, the operating system may be Windows XP or similar, Linux, MacOS or other suitable software. The application software on a typical personal computer system will almost invariably include word processing software e.g. Microsoft Word.

The application software 60 includes graphical user interface (GUI) code 64 that interacts with the operating system code to provide GUI functions to the software user. For example, in the case of a word processing package, when the user selects the ‘file’ option from the application toolbar by moving the mouse and clicking on the left mouse button, these user actions are detected and interpreted by the operating system. Operating system code calls a function provided by GUI code within the word processing software to cause the file menu to be created and displayed on the computer display. The execution of the GUI code to cause the display of the menu will result in a delay between the time when the user clicks the mouse button and the time the menu options are displayed. In this simple example, the time delay is small and may not be perceptible to the user. However, other more complex GUI functions will take longer to execute and the user can be inconvenienced by the delay while waiting to continue interaction with the application via the GUI.

In accordance with a preferred embodiment, this delay is reduced by making a prediction as to the next likely user input and pre-processing part of the GUI code that provides the required GUI function. If the prediction is correct, a further portion of the GUI code is executed and the GUI function completed. The prediction is performed by prediction code 62 that interacts with GUI code 64. The prediction code also provides for the maintenance and update of user input event records that are used in making the prediction. These records may conveniently be stored in non-volatile storage 30 within the computer system 10.

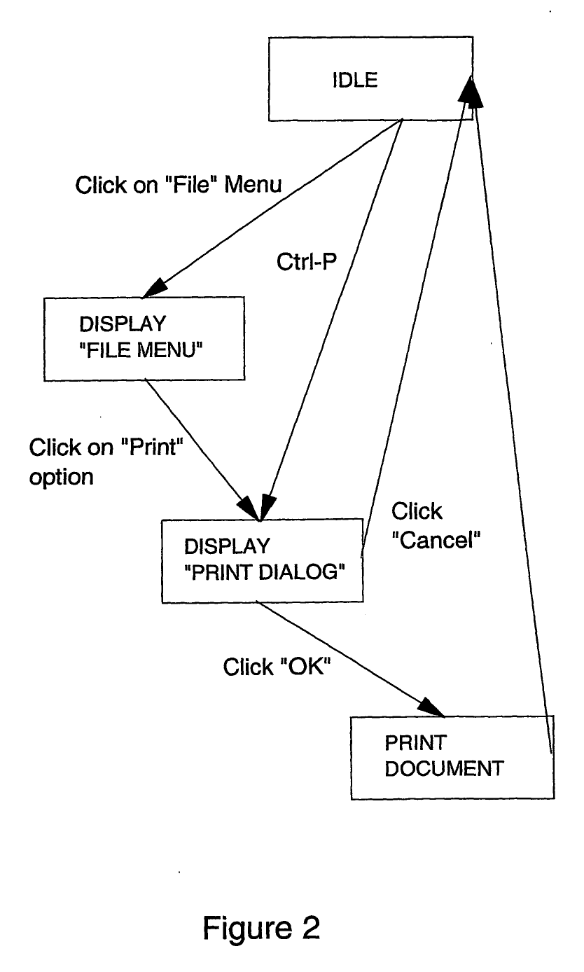

To help in understanding the operation of the described embodiment it is useful to consider the GUI provided by the computer program as a series of states. FIG. 2 shows a series of GUI states and the user inputs that bring about the transition from one state to another, such as moving the mouse, pressing a key, clicking on a menu item, etc. A block of GUI code which performs a function such as displaying a menu is associated with a transition to a GUI state.

In accordance with the preferred embodiment, each of these GUI functions is split into two blocks of code—a preparation block, and an activation block. FIG. 1 shows a representation of a plurality of GUI functions 1, 2, . . . N, each having a preparation block and an activation block i.e. P1,A1; P2,A2; . . . PN,AN. Executing the function involves executing the preparation block followed by the activation block. In accordance with the embodiment, the preparation block code is executed that has no side effects on the user data, and no visible clue that it has been performed. For instance, in the preparation block of “Display “File” menu”, GUI resources might be allocated to display a pop-up menu and all of the entries put into the menu. However the menu will not be displayed. In the activation block, all of the side effects associated with moving to that state are performed including modification of user data and visual changes to the GUI. In the activation block of “Display “File” menu”, the popup menu generated in the preparation block is displayed.

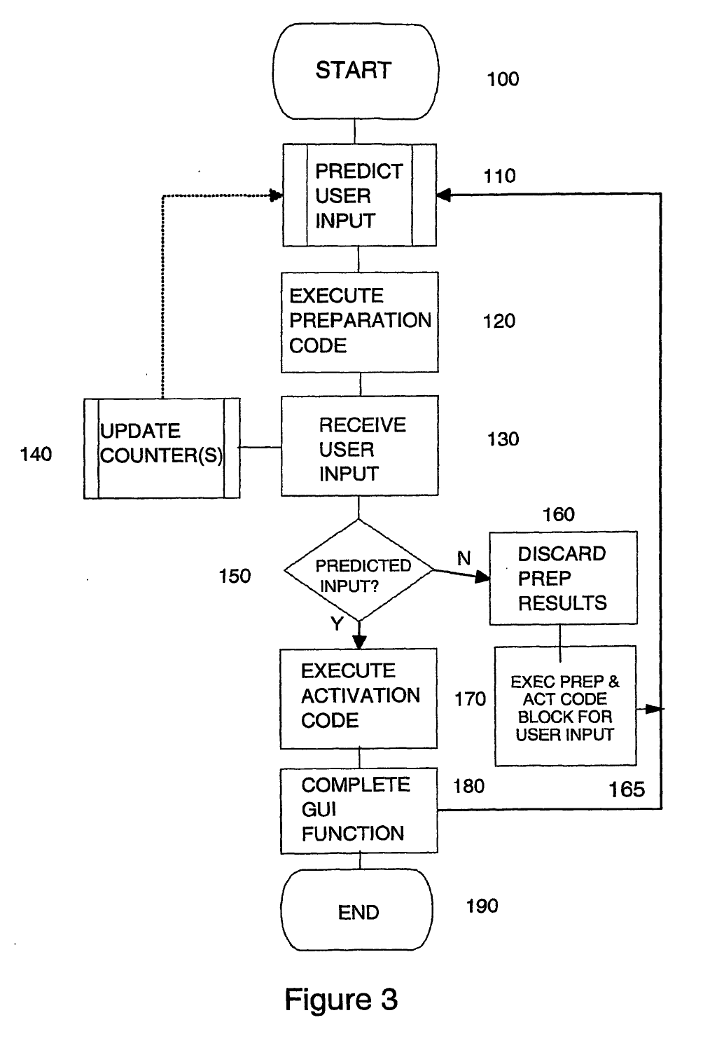

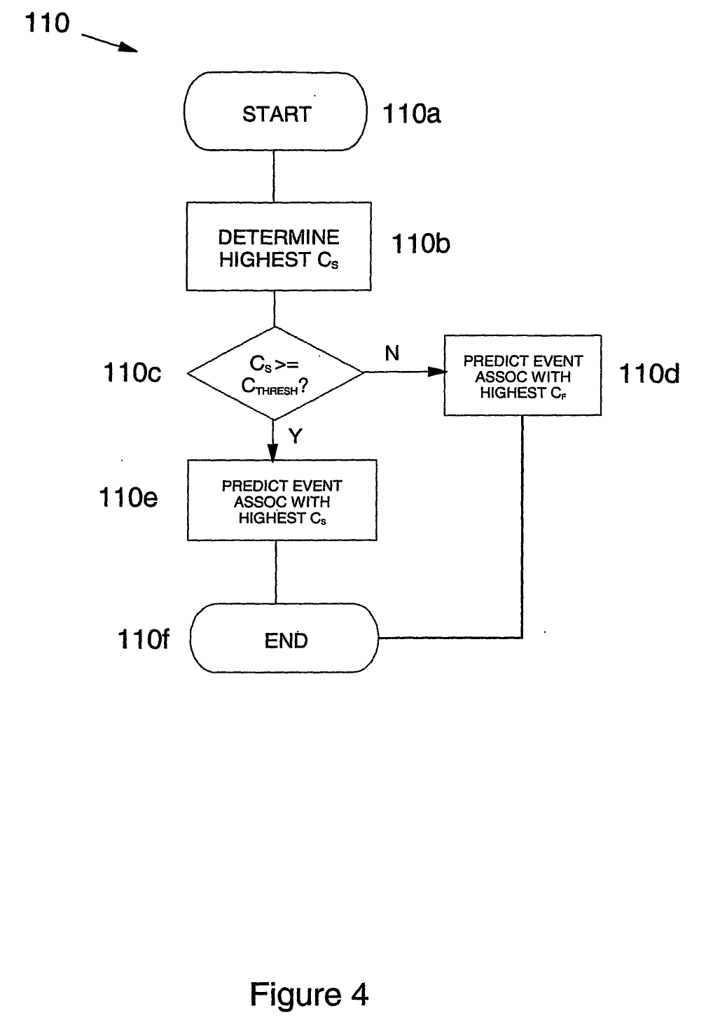

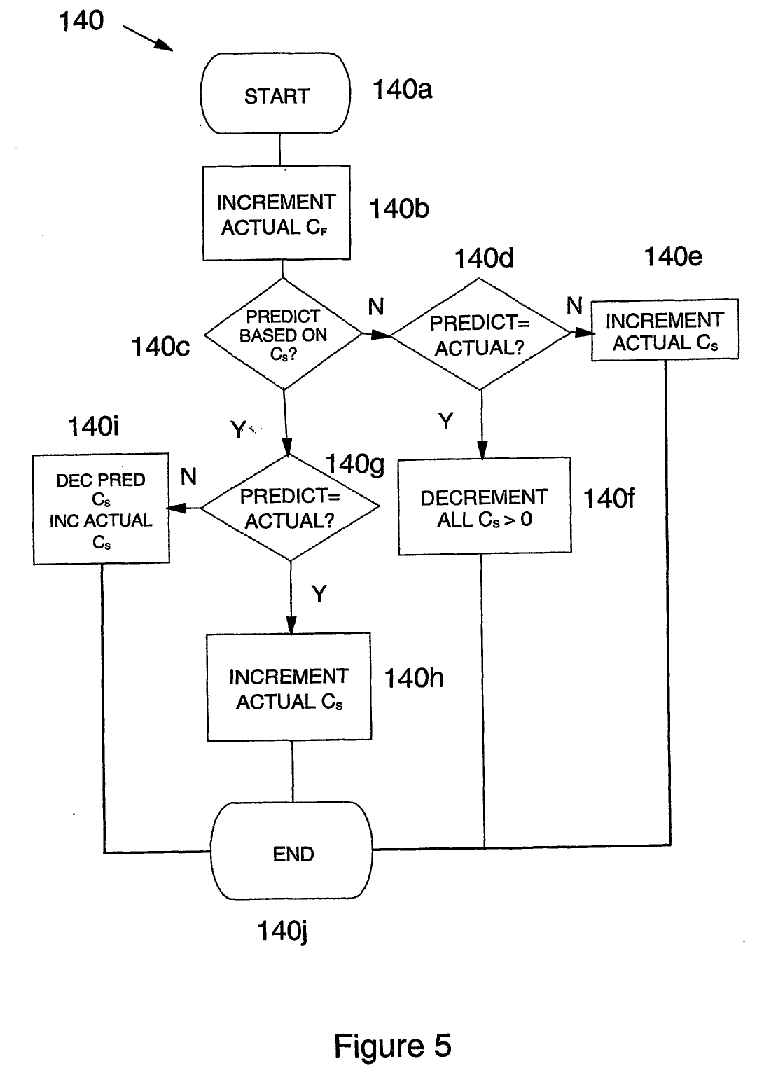

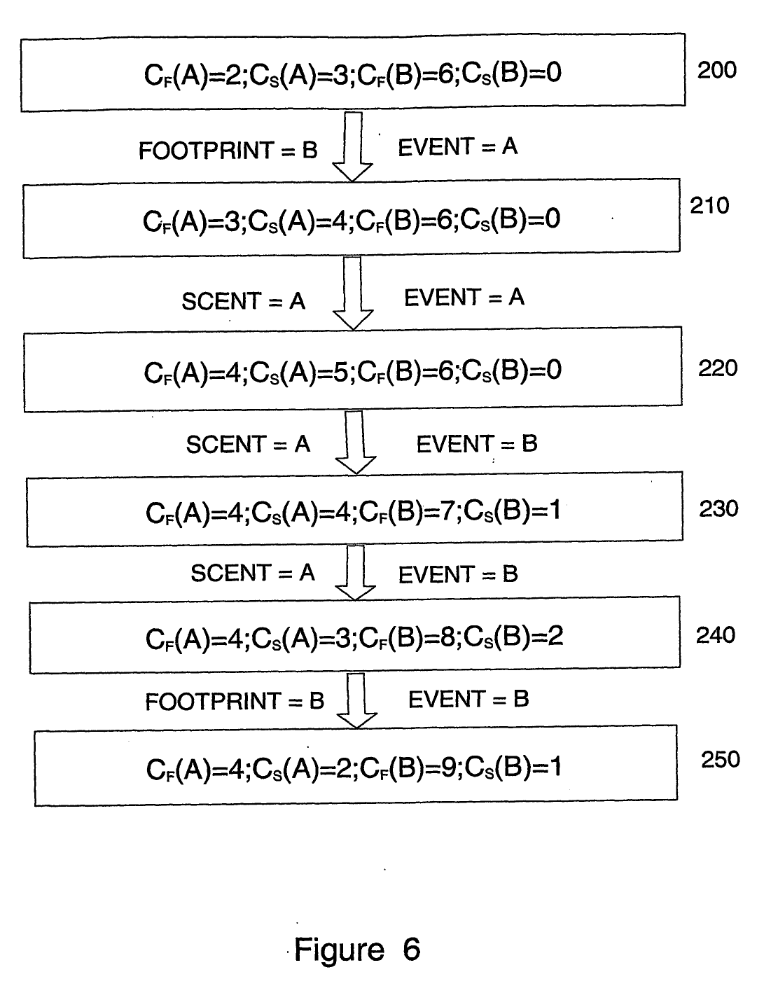

This process is shown in the flow diagram of FIG. 3. At ‘Start’ 100, the GUI can be considered to have completed a previous user-initiated GUI function. At step 110, a prediction is made as to the next user input. As indicated, this prediction involves the execution of a number of steps, details of which will be described below with reference to FIGS. 4 and 6. Once the prediction has been made, the preparation block associated with the predicted user event is executed and the results stored in non-volatile memory. In response to receiving the next user input at step 130 (which may happen when execution of the preparation code is complete or incomplete), the counters associated with the actual user event are updated in step 140 in accordance with the process set out in FIGS. 5 and 6, details of which will also be described below. A determination is made in step 150 as to whether the actual user input corresponds to the predicted user input. If not, the results of the execution of the preparation code are discarded, e.g. memory resources are released. The preparation and activation code blocks for the actual event are then executed at step 165 to complete the relevant GUI function.

If the actual user input is the same as the predicted input, the activation code block for the required GUI function is executed at step 170 and the GUI function completed at step 180. The process will then generally return to step 110 to predict the next user input. If however the last user input results in the closure of the application, then the process will end at step 190.

Thus during user interaction with the application program, a prediction is made as to the likely next user input. Once this prediction is made, the preparation block of the GUI code associated with the predicted user input is executed, using the idle time of the processing function. When the user provides the next input and it is as predicted, it is only necessary to execute the activation block. If it takes ‘n’ milliseconds to execute the preparation block, and ‘n’ milliseconds to execute the activation block, then from the user's perspective, this action has taken half as long as it used to.

Details of an example prediction technique will now be described with reference to FIG. 4. To predict the input that the user will make, it is necessary to determine the likelihood of performing a particular transition. In the preferred embodiment, this is achieved using techniques called “footprints” and “scents”. These techniques can be used independently or may be advantageously used in conjunction, depending on the particular software application being used.

“Footprints” work by having an integer counter on each transition in the following description the footprint counter is denoted generally as C_{F} and for each user event as C_{F} (event). Each time a transition is made, the counter C_{F} associated with the actual user input is increased by one. Over time as the application is used, a pattern will emerge based on the number of footprints that have trodden the path. A prediction that is based on the footprint counters is thus based on the long term history of user interactions with the particular application.

“Scents” are similar to footprints, but are a short term statistic—in the following description, a scent counter is denoted generally as C_{S} and for each user event as C_{S}(event). In general terms, the usefulness of this technique may be understood with reference to the following example. To take the example of a user inputting text data into a word processing document and where each keystroke is an event, footprints would suggest that the most likely next user input will be depression of the spacebar. Pre-emptive processing based on such a prediction may generally prove to be efficient. However, situations can be imagined where footprint-based predictions may not provide an improvement. Take for example the situation where the user is proposing to scroll to the top of the document by pressing the up arrow many times. As in the previous example, the footprint record indicates that the next most likely user input is depression of the spacebar. Even though the counter associated with the depression of the up arrow is increased by one each time the up arrow key is depressed, it may be the case that even on reaching the top of the document, there won't be as many footprints on the up arrow as there are on the spacebar. Thus each prediction will have been incorrect and no benefit provided to the user.

To address this possibility, a “scent” technique is provided. A scent is like a footprint in that its value increases each time a user event occurs, but the scent dissipates over time (the value is periodically decremented). A weak scent is considered more powerful than a strong footprint, and as such the probability of the user following a scented path could be higher than following a footprint laden path. So, each time the up arrow is depressed, the scent along that path increases and the prediction will tend towards the user pressing the up arrow again, not the spacebar. Once the user has finished pressing the up arrow, the scent will slowly reduce and the spacebar will be the most likely key to be pressed. Determining the relative importance of scents vs. footprints will need to be tuned to a particular application.

A specific embodiment of a prediction technique (step 110 in FIG. 3) based on scents and footprints will now be described with reference to FIGS. 4 and 6. The prediction starts at step 110a. At step 110b, a determination is made as to the highest value of C_{S}. In the example given in FIG. 6 which shows two possible user events A and B, the highest value of C_{S} shown in state 200 is associated with event A. This value is compared in step 110c of FIG. 5 with a threshold value for C_{S}. In the present example, this threshold is set at a value of 4. As C_{S} (A) is less than 4, a prediction is made in step 110d based on the event with the highest C_{F} which in state 200 is event B. The process ends at step 110f. If however, C_{S} is equal to or greater than the threshold (e.g. as at state 210 of FIG. 6) then a prediction is made based on the event having the largest value for C_{S}.

Thus the prediction is based on the values of the scent and footprint counters. The C_{S} and C_{F} values for each event are updated in accordance with the method set out in FIG. 5. FIG. 6 shows in greater detail how the values change in a particular example. The FIG. 5 method starts at step 140a. When a user input is received the value of C_{F} for the actual event is incremented. In step 140c, a determination is made as to whether the previous prediction was based on the value of C_{S}. If not (i.e. prediction was based on C_{F}), a determination is made at step 140d as to whether the actual user event corresponded to the predicted event. If not, C_{S} for the actual event is incremented and the process ended at step 140j. If however, the predicted event based on C_{F} is the same as the actual event, all C_{S} values greater than zero are decremented and the process then ends at step 140j. If, at step 140c, it is determined that the previous prediction was based on C_{S}, a determination is then made at step 140g as to whether the actual user event corresponded to the predicted event. If yes, the C_{S} for the actual event is incremented and the process ended at 140j. If not, C_{S} for the predicted event is decremented and C_{S} for the actual event is incremented.

The advantages of this scheme will be appreciated with reference to the example shown in FIG. 6 where each box denotes a GUI state. Included in each box are the scent and footprint counter values for two user events A and B. It will of course be appreciated that in an actual application, there may be many more user inputs possible at each GUI state and that these may change from one state to the next.

In ‘start’ state 200, the counter values are as depicted. In accordance with the steps set out in FIG. 4, a footprint based prediction is made that the next user input will be B. However, in this example, the next user input is actually A. Thus, in accordance with the method set out in FIG. 5, C_{F} (A) and C_{S} (A) are both incremented. The counters for event B are unchanged. This is depicted at state 210.

A prediction is again made in accordance with FIG. 4. In this case, C_{S} (A) is greater than the threshold value of 4 and thus a scent-based prediction is made that the next user event will be A. In this example, the next user event is in fact A. Thus, in accordance with the method set out in FIG. 5, C_{F} (A) and C_{S} (A) are both incremented. The counters for event B are unchanged. This is depicted at state 220.

A prediction is again made in accordance with FIG. 4. In this case, C_{S} (A) is equal to the threshold value of 4 and thus a scent-based prediction is made that the next user event will be A. In this example, the next user event is in fact B. Thus, in accordance with the method set out in FIG. 5, C_{F} (B) and C_{S} (B) are both incremented and C_{S} (A) is decremented. This is depicted at state 230.

A prediction is again made in accordance with FIG. 4. In this case, C_{S} (A) is equal to the threshold value of 4 and thus a scent-based prediction is made that the next user event will be A. In this example, the next user event is in fact B. Thus, in accordance with the method out in FIG. 5, C_{F} (B) and C_{S} (B) are both incremented and C_{S} (A) is decremented. Thus the scent associated with event A is decreased and the scent associated with event B is increased. This is depicted at state 240.

A prediction is again made in accordance with FIG. 4. In this case, C_{S} (A) is less than the threshold value of 4 and thus a footprint-based prediction is made that the next user event will be B. In this example, the next user event is in fact B. Thus, in accordance with the method out in FIG. 5, C_{F} (B) is incremented and both C_{S} (A) and C_{S} (B) are decremented. Thus, because the prediction was based on long term statistics, the scents associated with events A and B are decreased. This is depicted at state 250.

Alternative embodiments may be envisaged. When a prediction is made, it may be the case that several paths are reasonably likely to be followed (e.g. the prediction method may include a determination that the C_{F} values for several possible events are very similar). If the capacity of the processing function is sufficient, the preparation code for each of those functions can be executed. When the transition is finally known, the bad predictions can be made good by freeing any resources that their preparation holds. For instance, if a prediction is made that the user might click on the File menu, but doesn't, then the allocated GUI menu resources can be released.

Furthermore, if there are plenty of spare processing cycles, then the prediction technique may involve predicting a possible sequence of user events. For instance, if the user clicks on the “File” menu, a prediction might be made that the user will continue by clicking “Print” then “OK”. In this case, the preparation blocks for both events can be executed before the first prediction is confirmed. Again, bad predictions will need to be cleaned up as mentioned earlier.

The granularity of states and events employed in the prediction technique will vary from application to application and on the requirements of the user. For example, a coarse granularity may be used in which clicking on buttons and menu items are the only user events, or a finer granularity may be adopted in which a user event such as moving the mouse cursor north may be used to predict that the user is heading for the menu bar.

1. A method of operating an application program having a graphical user interface (GUI), the method including the steps of:
predicting a next user input to the GUI;
pending receipt of the next user input, executing a preparation portion of GUI code that provides the GUI function required by the predicted user input; and
determining whether the predicted user input corresponds to the actual next user input and, on a positive determination, processing an activation portion of said GUI code to complete the required GUI function.

2. A method as claimed in claim 1, including the further step of:
maintaining a history of user inputs to the GUI; wherein the step of predicting the next user input at a particular GUI state is based on an analysis of the history of previous user inputs at the particular GUI state.

3. A method as claimed in claim 1, including the further step of maintaining a history of user inputs to the GUI at each GUI state, the step of predicting the next user input at a particular GUI state comprising the step of determining whether to base the prediction on the maintained history or on a record of recent user inputs to the GUI.

4. A method as claimed in claim 1 wherein the prediction step comprises predicting a potential sequence of user inputs and the execution step comprises executing a preparation portion of GUI code for each of the user inputs of the predicted sequence.

5. A method as claimed in claim 1 wherein the prediction step comprises predicting a plurality of alternative potential user inputs and the execution step comprises executing a preparation portion of GUI code for each of the alternative user inputs.

6. Data processing apparatus comprising:
means for predicting a next user input to a graphical user interface (GUI) provided by the apparatus;
pending receipt of the next user input, means for executing a preparation portion of GUI code that provides the GUI function required by the predicted user input; and
means for determining whether the next received user input corresponds with the predicted next user input and, on a positive determination, for processing an activation portion of said GUI code to complete the required GUI function.

7. (canceled)

8. A computer-usable medium embodying computer program code, the computer program code comprising computer executable instructions configured to:
predict a next user input to the GUI;
pending receipt of the next user input, execute a preparation portion of GUI code that provides the GUI function required by the predicted user input; and
determine whether the predicted user input corresponds to the actual next user input and, on a positive determination, process an activation portion of said GUI code to complete the required GUI function.

9. The computer-usable medium of claim 8, wherein the embodied computer program code further comprises computer executable instructions configured to maintain a history of user inputs to the GUI; wherein the computer executable instruction configured to predict the next user input at a particular GUI state is based on an analysis of the history of previous user inputs at the particular GUI state.

10. The computer-usable medium of claim 8, wherein the embodied computer program code further comprises computer executable instructions configured to maintain a history of user inputs to the GUI at each GUI state, wherein the computer executable instruction configured to predict the next user input at a particular GUI state further comprises computer executable instructions configured to determine whether to base the prediction on the maintained history or on a record of recent user inputs to the GUI.

11. The computer-usable medium of claim 8, wherein:
the computer executable instructions configured to predict a next user input further comprises computer executable instructions configured to predict a potential sequence of user inputs; and
the computer executable instructions configured to execute a preparation portion of GUI code further comprises computer executable instructions configured to execute a preparation portion of GUI code for each of the user inputs of the predicted sequence.

12. The computer-usable medium of claim 8, wherein the computer executable instructions configured to predict a next user imputer further comprises computer executable instructions configured to predict a plurality of alternative potential user inputs; and
the computer executable instructions configured to execute a preparation portion of GUI code further comprises computer executable instructions configured to execute a preparation portion of GUI code for each of the user inputs of the predicted sequence.
